(19) United States
(12) Patent Application Publication
(10) Pub. No.: US 2019/0001868 A1
(43) Pub. Date: Jan. 3, 2019

(54) VEHICLE HEADLIGHT AND LIGHT DISTRIBUTION CONTROL DEVICE OF VEHICLE HEADLIGHT

(71) Applicant: Mazda Motor Corporation, Aki-gun (JP)

(72) Inventors: Akira Kaino, Hiroshima-shi (JP); Yoshitaka Fujihara, Hiroshima-shi (JP)

(21) Appl. No.: 15/986,204

(22) Filed: May 22, 2018

(30) Foreign Application Priority Data
Jun. 30, 2017 (JP) 2017-128846

(51) Int. Cl. B60Q 1/14

(52) U.S. Cl. CPC B60Q 1/1423; B60Q 2300/05; B60Q 2300/33; B60Q 2300/42; B60Q 2300/056

(57) ABSTRACT

The present invention provides a vehicle headlight that can improve visual responsiveness during nighttime driving. The vehicle headlight includes a processor configured to control at least one light source so as to radiate light directed to a road surface forward of a vehicle and form a first light distribution pattern having a hot zone at a central region in the vehicle width direction, and to radiate light toward a roadside forward of the vehicle and form a second light distribution pattern having a hot zone at a position offset outwardly in the vehicle width direction from the hot zone of the first light distribution pattern, in an overlapped area with the first light distribution pattern. The irradiation range of light directed at the objects on the roadside has an upper edge part that extends in a direction inclined inwardly in the vehicle width direction forward of the vehicle.

### FIELD OF THE INVENTION

The present invention relates to a vehicle headlight that radiates light to a road surface forward of a vehicle.

### BACKGROUND ART

In order to drive a vehicle such as an automobile more safely, when a visual change is generated in a driver's field of view, the driver's quick response to the change is necessary. If the driver's response to the visual change (hereinafter, referred to as “driver's visual responsiveness” or simply “visual responsiveness”) is deteriorated, the driver's response to an oncoming vehicle intruding into the driver's lane from an opposing lane, a pedestrian running out from the roadside into the roadway, and forwardly positioned obstacles may become slow.

FIG. 15 shows a region HO which exhibits a high visual responsiveness (hereinafter, referred to as “high visual responsiveness region”) in the driver's field of view during forward traveling in the daytime. As shown in FIG. 15, during forward traveling in the daytime, the high visual responsiveness region H0 is formed to stretch widely from a vicinity of an upper end part to a vicinity of a lower end part of a region in the crosswise direction including a viewpoint V1 in a field of view F1.

On the other hand, at night, when forward traveling while illuminating a road surface forward of the vehicle using headlights, the high visual responsiveness region becomes narrow compared with the daytime, and the driver's visual responsiveness is easily decreased. Therefore, in order to improve safety of nighttime traveling, the development of a headlight that can obtain for the driver, as much as possible, a visual responsiveness similar to that in the daytime is desired.

For headlight development, a light distribution pattern that is formed on a virtual vertical screen facing the vehicle from forward of the vehicle is considered. FIG. 16A shows an example of a light distribution pattern DH of a high-beam. FIG. 16B shows an example of a light distribution pattern DL of a low-beam. Moreover, FIG. 16A and FIG. 16B can be obtained by synthesizing the radiated light from the left and right headlights, and darker regions indicate higher illuminance.

As shown in FIG. 16A, in the light distribution pattern DH of the high-beam, usually, an irradiation area is approximately elliptic as a whole, a hot zone Z1 is formed in a central region in the vehicle width direction of the irradiation area and in an upper region more than a center region in the vertical direction. The light distribution pattern DH has an illuminance distribution in which the illuminance decreases further away from the hot zone Z1.

On the other hand, as shown in FIG. 16B, in the light distribution pattern DL of the low-beam, since the irradiated light in an upward region is cut in order to suppress glare to oncoming vehicles, a cutoff line CL is formed on the upper edge part of the irradiation area, and a hot zone Z2 is formed in the vicinity of a lower end region.

Moreover, in the example shown in FIG. 16B, a horizontal cutoff line CL is formed, which extends in the horizontal direction over the entire width of the vehicle width direction in the irradiation area. As another example of the light distribution pattern of the low-beam, for example, as shown in FIG. 12 and the like in PATENT DOCUMENT 1, while the horizontal cutoff line is formed in the region of the opposing lane side in the vehicle width direction in the irradiation area, an oblique cutoff line, which extends in an inclined upward direction toward the outer side of the vehicle width direction, might be formed in the opposite side region of the opposing lane.

### RELATED ART

### Patent Document

Patent Document 1

### Japanese Unexamined Patent Application Publication 2014-082165

### SUMMARY OF THE INVENTION

### Problems to be Solved by the Invention

Incidentally, based on the below-mentioned experimental results, the present inventor discovered that visual information, which can be clues to perceive a traveling direction of a vehicle, has a great influence on the visual responsiveness of a driver at the nighttime traveling.

Therefore, on the basis of this new knowledge, the present invention has an object of realizing a light distribution of a vehicle headlight that can improve the visual responsiveness of a driver while traveling at nighttime.

### Brief Summary of the Invention

To address the above issues, a vehicle headlight and a light distribution control device of the vehicle headlight according to the present invention are provided, which may be configured as follows.

A vehicle headlight according to a first aspect may include at least one light source configured to radiate light and a processor configured to control the at least one light source to direct light toward a road surface forward of a vehicle, for forming a first light distribution pattern having a hot zone in a central region in a vehicle width direction, and direct light directed to a roadside forward of the vehicle, for forming a second light distribution pattern, which has a hot zone on a position offset outwardly in the vehicle width direction from the hot zone of the first light distribution pattern, in an overlapped area with the first light distribution pattern. An irradiation range of light directed at objects on the roadside may have an upper edge part that extends in a direction inclined inwardly in the vehicle width direction forward of the vehicle.

Moreover, the “hot zone” in the present invention means a high illuminance region compared with other regions of the light distribution pattern. Further, the headlight in the present invention include at least one light source and may also have an optical system consisting of at least any one of a reflector, prism, lens, and shade. The components for directing the light for each light source may be completely mutually independent or may be partially shared. Thus, the same components may be used for some or all of the light sources or may be used selectively according to the traveling direction and the like of the vehicle.

In a second aspect, an upper edge part of the irradiation range may be a linear part arranged so as to extend toward a vanishing point in the field of view forward of the vehicle.

According to a third aspect, the illuminance of the hot zone of the second light distribution pattern may be equivalent to the illuminance of the hot zone in the first light distribution pattern.

According to a fourth aspect, the vehicle headlight may include at least one first light source for emitting light at a first wavelength, at least one second light source for emitting light at a second wavelength, and a processor configured to control the first and second light sources for forming a first irradiation area, to which the light emitted from the at least one first light source is radiated, and a second irradiation area, to which the light emitted from the at least one second light source is radiated, to be adjacent to each other, and for forming a boundary between the first irradiation area and the second irradiation area so as to extend toward the vanishing point, in the field of view forward of a vehicle.

Moreover, the “at least one first light source” and the “at least one second light source” may be completely mutually independent or may be partially shared. Thus, the same light source may function selectively as a light source of either the “at least one first light source” or the “at least one second light source” according to the traveling direction and the like of the vehicle.

According to a fifth aspect, the vehicle headlight may include at least one light source configured to radiate light and a processor configured to control the at least one light source to radiate light with a first illuminance toward a first irradiation area in the field of view forward of a vehicle, form a second irradiation area having a contour part extended toward the vanishing point in the field of view forward of the vehicle, and radiate light with a second illuminance toward the second irradiation area.

According to a sixth aspect, the vehicle headlight may further comprise a camera for filming scenes forward of the vehicle, and the processor may be further configured to calculate the vanishing point based on the filmed scenes.

### Effects of the Invention

According to the vehicle headlight according to first aspect above, since the objects on the roadside are brightly illuminated, in the irradiation range of light toward the roadside, a contour of an upper edge part that extends in a direction inclined inwardly in the vehicle width direction forward of the vehicle is easily perceived by a driver. Therefore, the driver easily perceives the traveling direction of the vehicle based on the direction, to which the upper edge part of the irradiation range of light toward the roadside extends. Accordingly, since the visible space cognitive function of the driver is easily well performed, the visual responsiveness of the driver during nighttime driving can be improved, so that safety during nighttime driving can be enhanced.

According to the second aspect, by arranging the upper edge part of the irradiation range of light toward the roadside so as to extend toward the vanishing point in the field of view forward of the vehicle, the driver may perceive the position of the vanishing point, and consequently it is easy to accurately perceive the traveling direction of the vehicle. Therefore, the visible space cognitive function of the driver is easily performed better, so that safety during nighttime driving can be effectively improved.

According to the third aspect, by illuminating the objects on the roadside by light with high illuminance, it is easy to visually recognize the contour of the upper edge part of the light irradiation range clearly. Accordingly, the visible space cognitive function of the driver is easily performed better, so that safety during nighttime driving can be effectively improved.

According to the vehicle headlight according to the fourth aspect, based on the direction to which a color boundary of the irradiated light in the field of view forward of the vehicle extends, the driver may easily perceive the position of the vanishing point, and consequently the traveling direction of the vehicle. Accordingly, since the visible space cognitive function of the driver is easily well performed, the visual responsiveness of the driver during nighttime driving can be improved, so that safety during the nighttime driving can be enhanced.

According to the vehicle headlight according the fifth aspect, based on the direction in the first irradiation area to which the contour part of the second irradiation area extends, the driver may easily perceive the position of the vanishing point, and consequently the traveling direction of the vehicle. Accordingly, since the visible space cognitive function of the driver is easily well performed, the visual responsiveness of the driver during nighttime driving can be improved, so that safety during nighttime driving can be enhanced.

According the sixth aspect of the invention, during nighttime driving, based on the scenes forward of the vehicle that are filmed by the camera, the vanishing point in the field of view forward of the vehicle can be accurately calculated. Therefore, the light distribution control of the headlight according to the position of the vanishing point can be performed accurately, so that safety during nighttime driving can be enhanced effectively.

### BRIEF DESCRIPTION OF THE DRAWINGS

FIG. 1 is a top plan view schematically showing a vehicle that has a vehicle headlight according to a first embodiment of the present invention.

FIG. 2 is a drawing showing an example of light source of the headlight according to the first embodiment.

FIG. 3 is a drawing showing a light distribution control system of the headlight.

FIG. 4 is a flow chart showing an example of the light distribution control of the headlight.

FIGS. 5A to 5C are illuminance distribution diagrams showing light distribution patterns of the headlight.

FIG. 6 is a drawing showing an example of an irradiation range of light in a field of view forward of the vehicle.

FIG. 7 is a graph showing a setting example of irradiation percentages of each light source part of the light source shown in FIG. 2.

FIG. 8 is a drawing showing a modified example of the light source of the headlight.

FIGS. 9A and 9B are drawings showing an irradiation aspect and a light distribution pattern of light from the headlight according to a second embodiment.

FIG. 10 is a drawing showing an example of the light source of the headlight according to the second embodiment.

FIGS. 11A and 11B are drawings showing an irradiation aspect and a light distribution pattern of light from the headlight according to a third embodiment.

FIGS. 12A and 12B are drawings showing a driving simulator and monitor compartments that are used for experiments.

FIGS. 13A to 13C are drawings showing monitor images of respective experiments of comparative examples, for each of the first embodiment and the second embodiment.

FIGS. 14A to 14C are distribution diagrams of visual responsiveness showing an outcome of each experiment of the comparative example, for each of the first embodiment and the second embodiment.

FIG. 15 is a drawing showing a high visual responsiveness region during daytime driving.

FIGS. 16A and 16B are drawings showing general light distribution patterns of high-beams and low-beams.

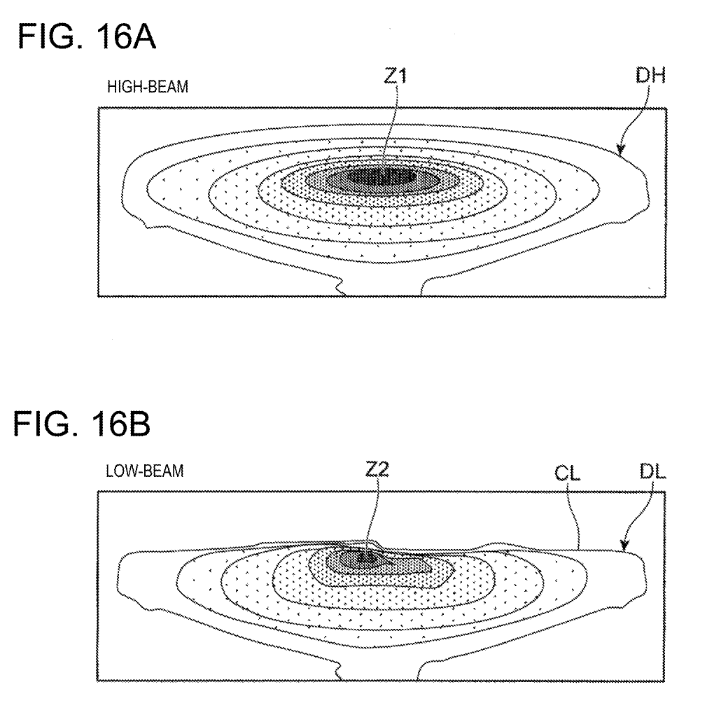

### DETAILED DESCRIPTION OF THE EMBODIMENTS

Hereinafter, embodiments of the present invention will be described with reference to attached figures.

### Experiment

First of all, for the purpose of inventing a vehicle headlight and a light distribution control device thereof that can effectively suppress the deterioration of the visual responsiveness of a driver at the nighttime traveling, experiments carried out by the present inventors will be described.

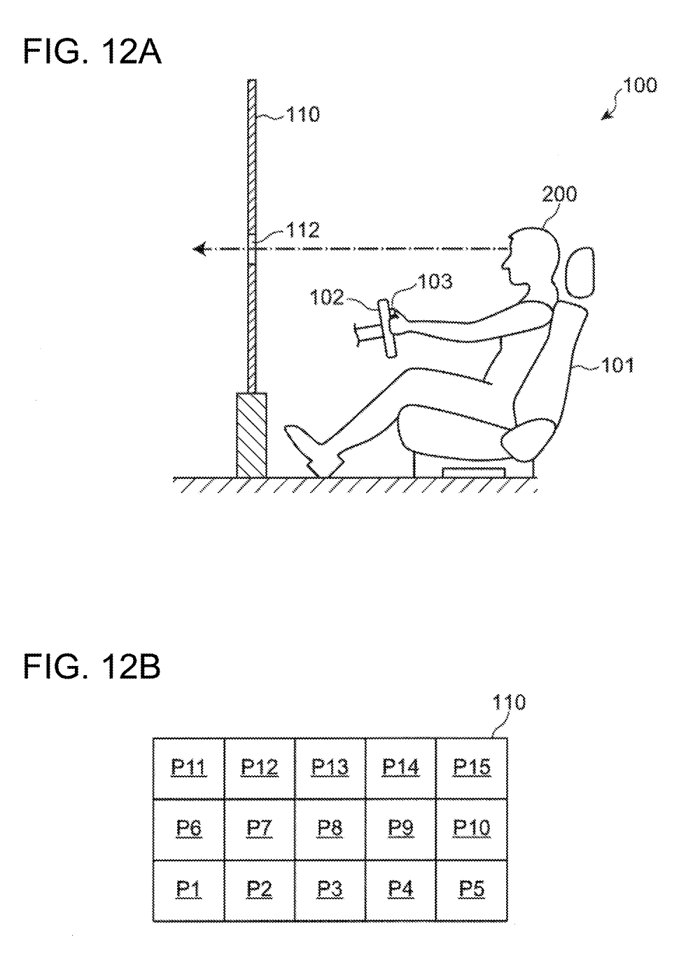

In an experiment, a driving simulator 100 shown in FIG. 12A was used. The driving simulator 100 included a driver seat 101, a steering wheel 102, and a monitor 110. An operation button 103 was specially provided on the steering wheel 102 for the experiment.

The monitor 110 was arranged forward of the driver seat 101 and an image resembling a scene that can be seen from the driver seat was displayed on the monitor 110. An opening part 112 was provided on a center of the monitor 110. The opening part 112 was arranged on a position facing the eyes of a driver 200.

As shown in FIG. 12B, the monitor 110 was segmented into five columns in a crosswise direction and three rows in a vertical direction and had a total of 15 compartments of P1 to P15. A circular indicator could be displayed on a central part of each of the compartments P1 to P15. When viewing from the point of view of the driver, an angle range in the crosswise direction from a left end part to a right end part of each compartment of P1 to P15 was 20 degrees, and an angle range in the vertical direction from an upper end part to a lower end part was 17 degrees.

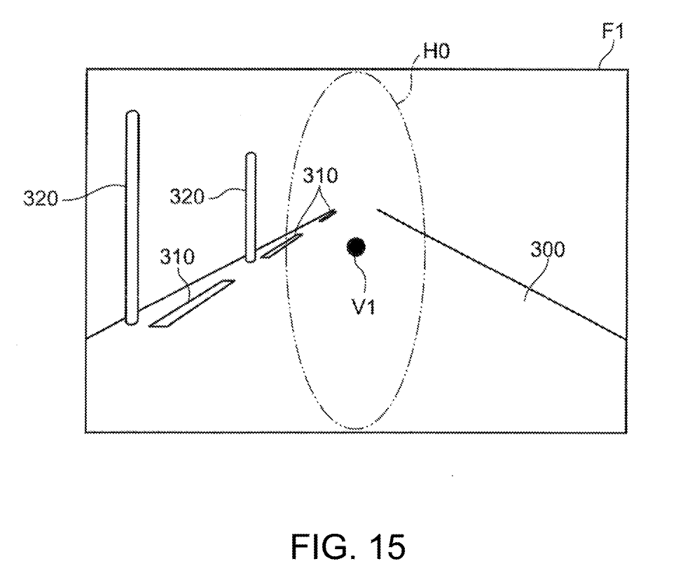

In the experiment, an image resembling the field of view of the driver was displayed on the monitor 110 when traveling on a flat straight road 300 as shown in FIG. 15 at 100 kilometers per hour at nighttime. A white line 310 was intermittently arranged on a left side of the straight road 300 as a roadway boundary line. A plurality of utility poles 320 were arranged at intervals on the roadside strip outside of the white line 310 in the vehicle traveling direction.

Moreover, in the experiment, the above indicator was displayed on any one of the compartments P1 to P15 once every few seconds on the monitor 110 on which the image displayed. The compartments P1 to P15, on which the indicator was displayed, were switched randomly.

In the experiment, the driver 200 was directed to keep watching the opening part 112 so that the center of the monitor 110 was a fixation point, and to push an operation button 103 as soon as possible when the indicator was displayed on any of the compartments P1 to P15 on the monitor 110.

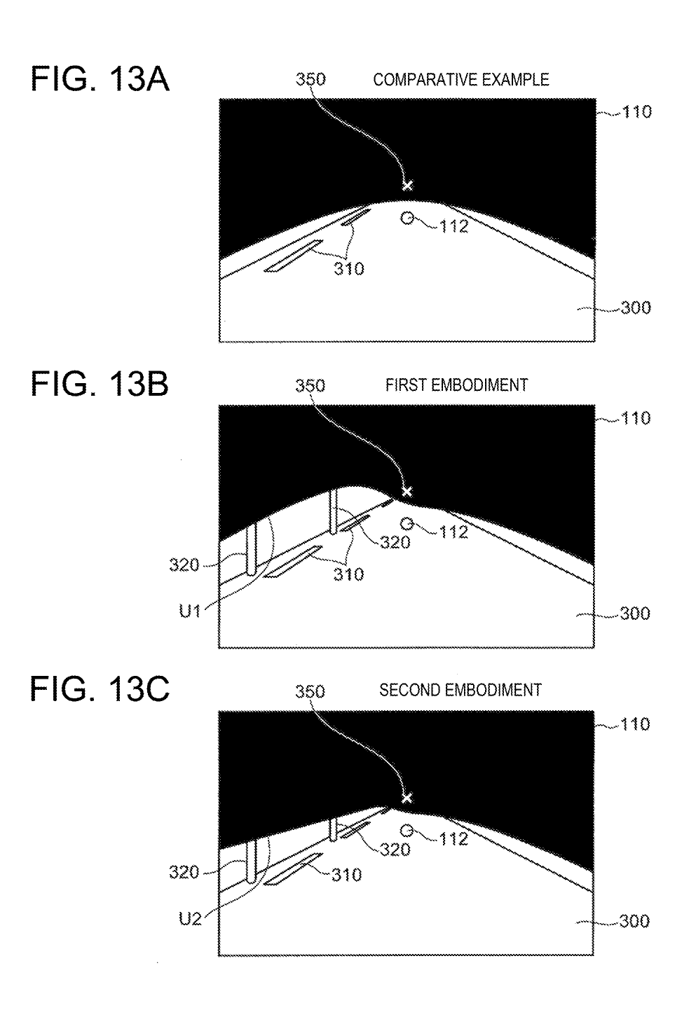

The experiments were carried out respectively for a comparative example displaying an image shown in FIG. 13A, the first embodiment displaying an image shown in FIG. 13B, and the second embodiment shown in FIG. 13C.

In the comparative example shown in FIG. 13A, utility poles 320 were removed from the scene shown in FIG. 15, and a scene of nighttime driving in a general state in which the low-beams were irradiated to the road surface was displayed on the monitor 110.

In the first embodiment shown in FIG. 13B and the second embodiment shown in FIG. 13C, a scene during nighttime driving in a state in which light was irradiated to not only the road surface but also the roadside was displayed on the monitor 110. In the first embodiment and the second embodiment, a part of the lower side of the utility poles 320 could be visually recognized by irradiating light toward the roadside.

In the first embodiment, an upper edge part U1 of the irradiation range of light toward the roadside was arranged approximately in parallel to the left side end part of the straight road 300. In the second embodiment, an upper edge part U2 of the irradiation range of light toward the roadside was arranged to be linearly extended toward a vanishing point 350, so that the irradiation range of light toward the roadside was narrower than that in the first embodiment.

In this experiment, the driving simulations were carried out respectively for the comparative example, the first embodiment, and the second embodiment. While carrying out each driving simulation, every time when the indicator was displayed on the monitor 110, the response time of the driver 200 thereto was measured. Specifically, a time required, which is from the point in time at which the display of the indicator started until the point in time at which the operation button 103 was pushed, was measured as the response time.

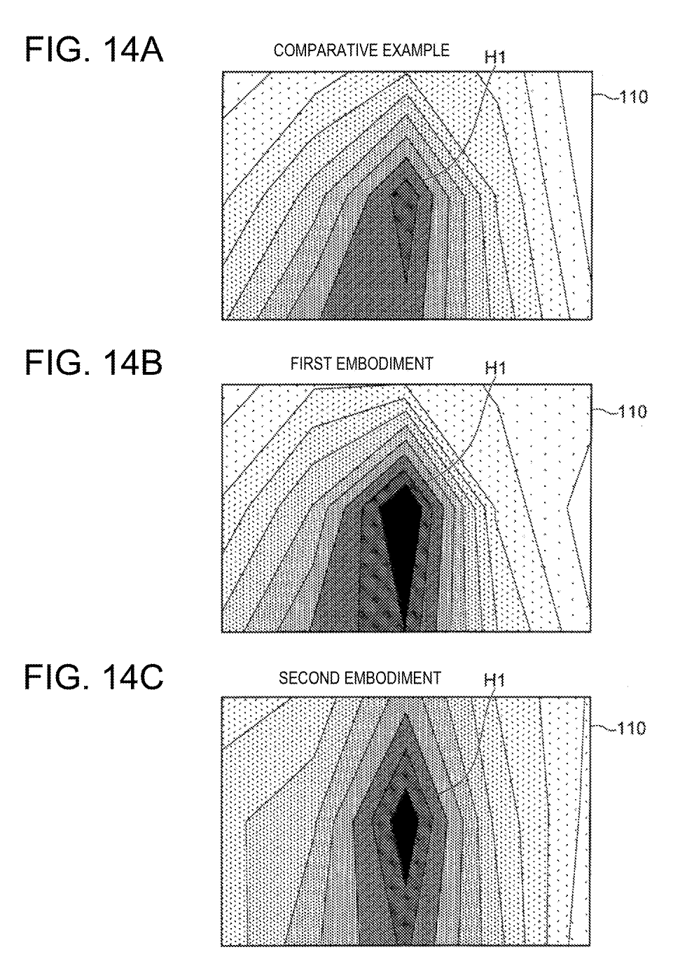

Each of the measurement results are shown in FIG. 14A for the comparative example, FIG. 14B for the first embodiment, and FIG. 14C for the second embodiment. Specifically, FIGS. 14A to 14C show distributions of the response time in whole regions of the monitor 110. In each distribution diagram of FIGS. 14A to 14C, the region with darker color shows a faster response from the driver 200.

Compared with the measurement results of the comparative example shown in FIG. 14A, the first embodiment shown in FIG. 14B and the second embodiment shown in FIG. 14C show that the overall response times of the first embodiment and the second embodiment are shorter than that of the comparative example. Moreover, a high visual responsiveness region H1 of the second embodiment is formed to be elongated upward compared with that of the first embodiment and is a region that approximates a high visual responsiveness region H0 during daytime driving (refer to FIG. 15). Ultimately, this shows that the second embodiment, as compared to the first embodiment, can obtain high visual responsiveness over a wider range, especially in the vertical direction.

Moreover, in any of the comparative example, the first embodiment, and the second embodiment, the lower part of each region of the distribution diagrams shown in FIG. 14A, FIG. 14B, and FIG. 14C are spread to the left side. The cause of this is assumed to be that the awareness of the driver 200 easily leans to the lower left part since the white line 310 positioned to the left side of the road surface gives one clue to perceive the traveling direction of the vehicle.

Based on the above results of the experiments, the present inventor obtained knowledge as follows. First, during nighttime driving when the general low-beams are used as shown the comparative example in FIG. 13A, because of a lack of visual information other than the road surface, the visual information, which can be a clue to perceive the traveling direction of the vehicle, becomes poor, so that the visible space cognitive function of the driver 200 is deteriorated, and consequently this is assumed to cause the deterioration of the visual responsiveness.

On the other hand, in the first embodiment shown in FIG. 13B and the second embodiment shown in FIG. 13C, by irradiating light of the headlight to a part of the lower side of the utility poles 320 on the roadside, the contours of the upper edge parts U1 and U2 of the irradiation range of light to the utility poles 320 can be perceived, based on the direction, to which the upper edge parts U1 and U2 of the irradiation range extend, the traveling direction of the vehicle may be easily perceived. Therefore, by brightly illuminating the roadside with the headlight, effective visual information may be obtained as a clue to perceive the traveling direction of the vehicle.

Further, in the second embodiment, since the upper edge part U2 of the irradiation range is formed linearly toward the vanishing point 350, it may be easy to accurately perceive the vanishing point 350, and consequently the traveling direction of the vehicle. Accordingly, by irradiating light so as to easily perceive the position of the vanishing point 350, the visible space cognitive function of the driver 200 is performed well, so that the visual responsiveness can be improved.

On the basis of the above new knowledge, in order to improve the visual responsiveness of the driver during nighttime driving, the vehicle headlight and the light distribution control device thereof according to the following embodiments are provided. Hereinafter, the specific configuration of a vehicle headlight and a light distribution control device thereof will be described for each embodiment.

### First Embodiment

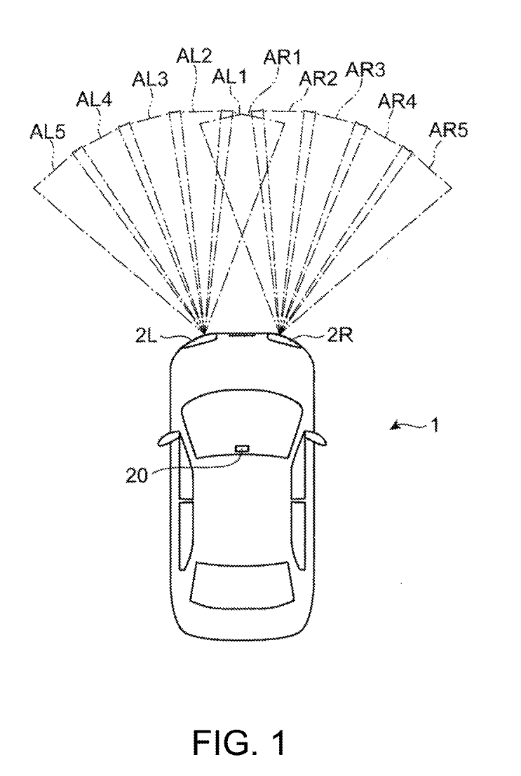

FIG. 1 is a top plan view showing a vehicle 1 that has a vehicle headlight according to a first embodiment. A pair of left and right headlights 2L and 2R are provided on a front edge part of the vehicle 1 as the “vehicle headlight.”

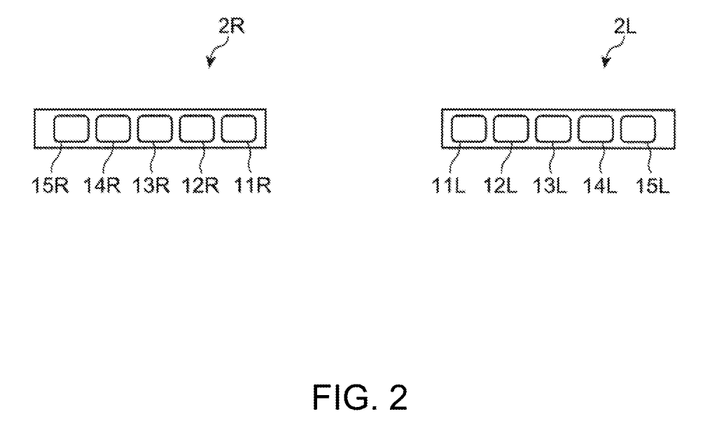

An example of the configuration of the light source(s) of the headlights 2L and 2R will be described with reference to FIG. 2. In the example shown in FIG. 2, each headlight 2 (2L and 2R) has a plurality of light source parts 11 (11L and 11R), 12 (12L and 12R), 13 (13L and 13R), 14 (14L and 14R), and 15 (15L and 15R). A plurality of light source parts 11, 12, 13, 14, and 15 are arranged side by side on each headlight 2 in the vehicle width direction.

More specifically, each headlight 2 has a first light source part 11, a second light source part 12, a third light source part 13, a fourth light source part 14, and a fifth light source part 15, and these light source parts 11, 12, 13, 14, and 15 are arranged side by side in this order from inside to outside in the vehicle width direction.

Moreover, in the example shown in FIG. 2, each headlight 2 has five light source parts 11, 12, 13, 14, and 15; however, the number of light source parts on each headlight 2 is not particularly limited.

Each of the light source parts 11, 12, 13, 14, and 15 have at least one light-emitting diode (LED) element (not shown). An On/Off state of each of the light source parts 11, 12, 13, 14, and 15 can be individually controlled for each light source part. Moreover, the light quantity emitted from each of the light source parts 11, 12, 13, 14, and 15 can be individually adjusted for each light source part.

The headlight 2 also has an optical system 23 consisting of at least any one of a reflector, a prism, a lens, and a shade in addition to the light source parts 11, 12, 13, 14, and 15. Light emitted from each of the light source parts 11, 12, 13, 14, and 15 is irradiated toward mainly the road surface forward of the vehicle 1 via the optical system 23. It will be appreciated that as discussed above, each light source part 11, 12, 13, 14, and 15 may have a respective optical system 23, may share components of respective optical systems 23, or may share one or more optical systems 23 entirely.

As shown in FIG. 1, the irradiation range of light from the headlight 2 in a plan view is different for each light source part 11, 12, 13, 14, and 15. The irradiation ranges AL1 and AR1 of light from the first light source part 11, the irradiation ranges AL2 and AR2 of light from the second light source part 12, the irradiation ranges AL3 and AR3 of light from the third light source part 13, the irradiation ranges AL4 and AR4 of light from the fourth light source part 14, and the irradiation ranges ALS and ARS of light from the fifth light source part 15 are arranged side by side in this order from inside to outside in the vehicle width direction.

Moreover, a camera 20 that films a forward scene of the vehicle 1 is provided on the vehicle 1. The camera 20 is an imaging means having an imaging element such as a charge-coupled device (CCD), a complementary metal-oxide-semiconductor (CMOS), or the like. The camera 20 is provided, for example, on the central part in the vehicle width direction of the vehicle 1. More specifically, the camera 20 is arranged facing forward of the vehicle 1. For example, the camera 20 may be arranged on the back side of a rear-view mirror.

### Light Distribution Control

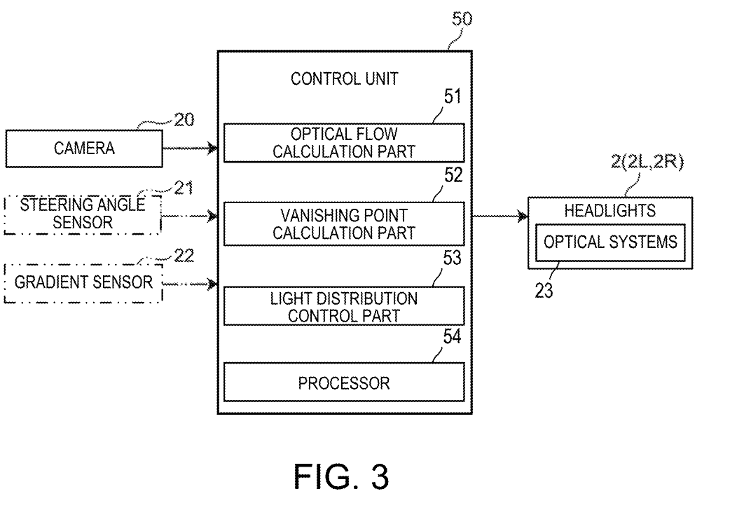

As shown in FIG. 3, the light distribution of the headlight 2 is controlled by a control unit 50. The control unit 50 is configured as a microprocessor as a main part, for example. The control unit 50 has a processor 54 (central processing unit), memory such as RAM and ROM, and an input/output interface circuit. The processor 54 is configured to execute various software parts in order to achieve their corresponding functions.

The control unit 50 has an optical flow calculation part 51 for calculating an optical flow (forward scene flows of vehicle 1) based on signals input from the camera 20, a vanishing point calculation part 52 for calculating a position of the vanishing point in the field of view forward of the vehicle 1 based on the optical flow calculated by the optical flow calculation part 51, and a light distribution control part 53 for controlling the light distribution of the headlight 2.

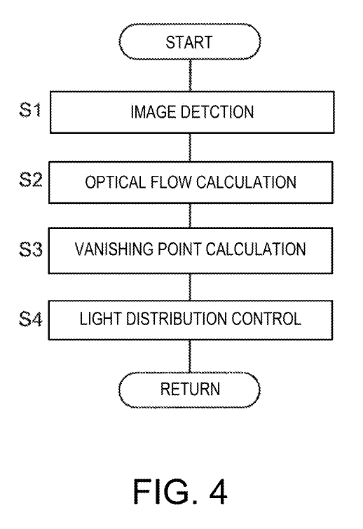

An example of the flow of the light distribution control of the headlight 2 will be described with reference to the flow chart shown in FIG. 4. A series of controls shown in FIG. 4 are executed repeatedly while the headlight 2 is on.

At step S1, a forward scene of the vehicle 1 is filmed by the camera 20. Specifically, the camera 20 continuously films scenes as a moving image.

At the next step S2, an optical flow is calculated by the optical flow calculation part 51 based on the moving image filmed by the camera 20. The “optical flow” calculated at this point may, for example, express the movement of the objects in the moving image in a vector.

At the next step S3, by the vanishing point calculation part 52, a plurality of representative vectors are selected among the vectors that are calculated by the optical flow calculation part 51 and a position of an intersection of extended lines of these vectors is calculated as the position of the vanishing point. Accordingly, the position of the vanishing point in the field of view is calculated by the camera 20. This calculation value may be converted into the position of the vanishing point in the field of view of the driver by a predetermined correction.

At step S4, the light distribution of the headlight 2 is controlled by the light distribution control part 53 based on the position of the vanishing point calculated at the step S3. Hereinafter, a specific example of the light distribution control of the headlight 2 will be described.

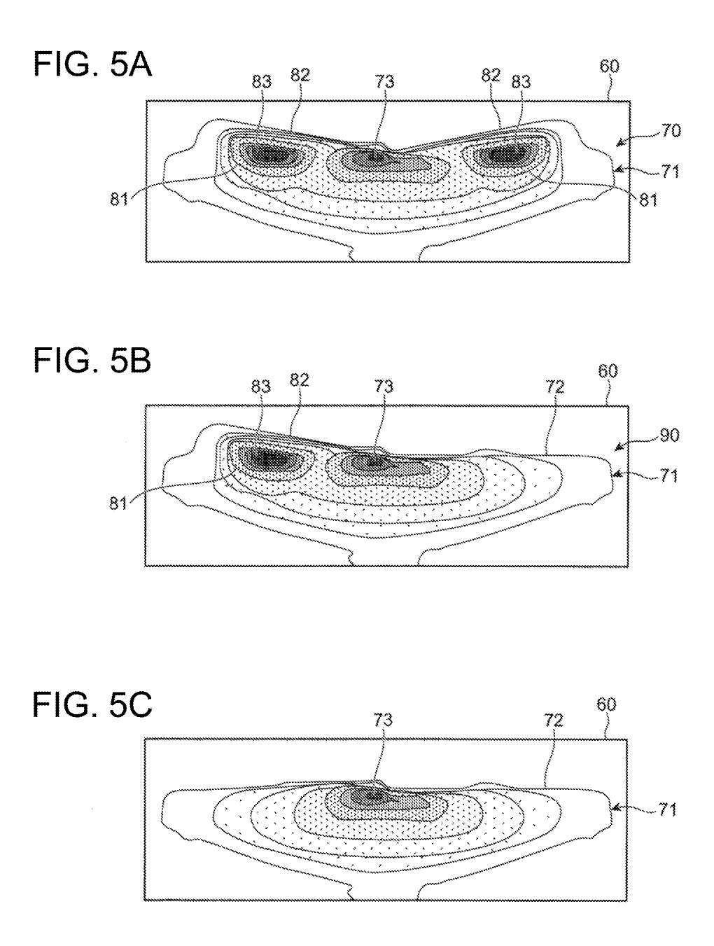

A specific example of the light distribution pattern when the low-beam is on will be described with reference to FIGS. 5A to 5C. FIG. 5A shows an example of a light distribution pattern 70 according to the present embodiment, FIG. 5B shows a light distribution pattern 90 according to another example, and FIG. 5C shows a first light distribution pattern 71 configured in the same way as the general light distribution pattern of the low-beam.

The light distribution patterns 70, 71, and 90 shown in FIGS. 5A to 5C are formed when light from the bilateral headlights 2L and 2R are irradiated to a virtual vertical screen 60 directly facing forward of the vehicle 1. The virtual vertical screen 60 is arranged normal to the longitudinal direction of the vehicle 1 at a position 25 m ahead of the vehicle 1. Each of the light distribution patterns 70, 71, and 90 show the irradiation range and the illuminance distribution of light on the virtual vertical screen 60. In each of the light distribution patterns 70, 71, and 90, a plurality of illuminance regions is segmented by an isolux curve, and they show that the deeper color the region is, the higher the illuminance is.

The light distribution pattern 70 shown in FIG. 5A consists of combining the first light distribution pattern 71 shown in FIG. 5C and a pair of second light distribution patterns 81 that are formed on the area overlapping with the first light distribution pattern 71 on the virtual vertical screen 60.

The first light distribution pattern 71 shown in FIG. 5C has the same light distribution pattern of the conventional low-beam and has a horizontal cutoff line 72 formed on the upper edge part and a hot zone 73 formed immediately under the horizontal cutoff line 72 at a central region of the vehicle width direction.

The first light distribution means forming the first light distribution pattern 71 has, for example, the first, second, third, and fifth light source parts 11, 12, 13, and 15 as the light source of the headlight 2 and an optical system 23 corresponding to the light source parts thereof, and is configured so as to radiate light toward the road surface forward of the vehicle 1.

As shown in FIG. 5A, the second light distribution patterns 81 are formed respectively at the positions offset to the left side and the right side from the center in the vehicle width direction. A pair of second light distribution patterns 81 are formed symmetrically. A hot zone 83 of the second light distribution pattern 81 is arranged at a position of approximately the same height in the vertical direction and arranged to be offset to the vehicle width direction compared with the hot zone 73 of the first light distribution pattern 71.

The illuminance of the hot zone 83 of the second light distribution pattern 81 is the same or higher than the illuminance of the hot zone 73 of the first light distribution pattern 71. Moreover, the hot zone 83 of the second light distribution pattern 81 is formed wider than the hot zone 73 of the first light distribution pattern 71.

The second light distribution pattern 81 is formed to overhang more toward the upper side than the upper edge part of the first light distribution pattern 71. Accordingly, a pair of oblique cutoff lines 82 respectively extending obliquely upward toward both right and left sides from the center in the vehicle width direction are formed on the light distribution pattern 70 that consists of a combination of the first light distribution pattern 71 and a pair of second light distribution patterns 81.

The second light distribution means forming the second light distribution pattern 81 has for example, the fourth light source part 14 among the light source of the headlight 2 and the corresponding optical system 23 thereof and is configured so as to radiate light directed toward the roadside.

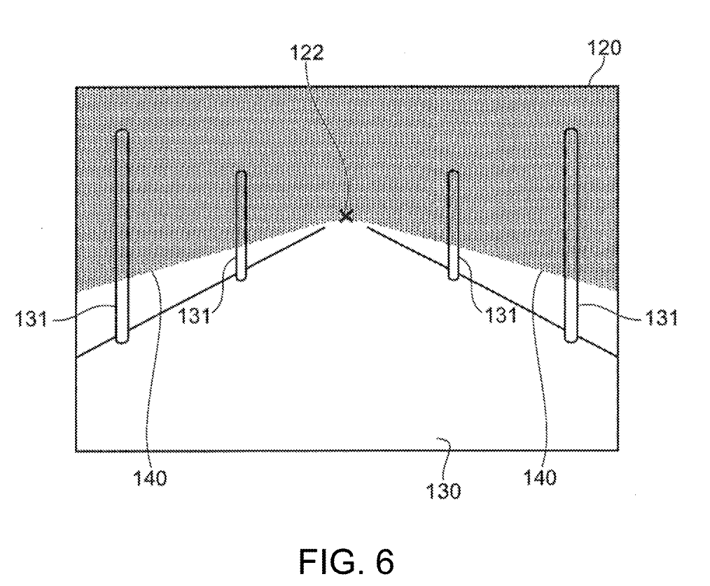

When the light distribution pattern 70 shown in FIG. 5A is formed, as shown in FIG. 6, light from the headlight 2 is irradiated to not only the road surface 130 frontward of the vehicle 1 but also the objects such as buildings or utility poles 131 exist on the roadside.

Since the hot zone 83 of the second light distribution pattern 81 forming the light irradiated toward the objects on the roadside has equal or more illuminance of the hot zone 73 of the first light distribution pattern 71, the objects on the roadside are brightly illuminated same as the road surface. Therefore, the contour of the upper edge part 140 of the irradiation range of light directed toward the roadside is easily perceived by the driver. Accordingly, in the present embodiment, not only the conventional two-dimensional light distribution directed to the road surface but also the three-dimensional light distribution focusing on the irradiation directed to the objects on the roadside are designed.

Therefore, according to the present embodiment, based on the direction, to which the upper edge part 140 of the irradiation range of light directed toward the roadside extends, the driver may easily perceive the traveling direction of the vehicle 1. Accordingly, since the visible space cognitive function of the driver is easily well performed, the visual responsiveness of the driver during nighttime driving can be improved, so that safety during nighttime driving can be enhanced.

At this point, the upper edge part 140 of the irradiation range of light directed toward the roadside is formed linearly extending toward the direction inclined inwardly in the vehicle width direction forward of the vehicle 1, more specifically, is formed linearly toward the vanishing point 122 in the field of view 120 forward of the vehicle 1 of the driver or the camera 20. Accordingly, the driver easily perceives the position of the vanishing point, consequently the traveling direction of the vehicle 1 with higher accuracy, so that the visible space cognitive function of the driver is easily performed better.

Moreover, the contour of the upper edge part 140 of the irradiation range of light directed toward the roadside may not necessarily be linear but may be a curved line.

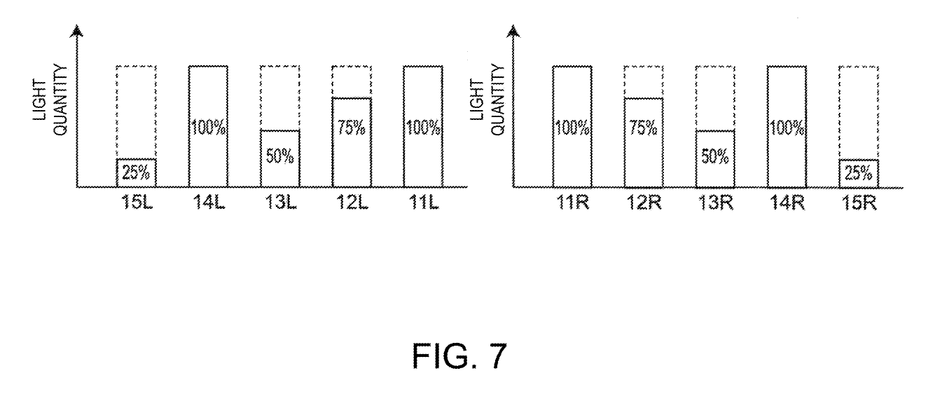

In order to form the light distribution pattern 70 shown in FIG. 5A by the bilateral headlights 2L and 2R, the light quantities emitted from each of the light source parts 11, 12, 13, 14, and 15 of the headlights 2L and 2R are set as shown in FIG. 7, for example. The ratios of the light quantities of each of the light source parts 11, 12, 13, 14, and 15 to the maximum light quantity are shown in FIG. 7. Moreover, the maximum light quantities of the first to the fifth light source parts 11 to 15 are all equal.

In the example shown in FIG. 7, the light quantities of the first, the second, the third, and the fifth light source parts 11, 12, 13, and 15 forming the first light distribution pattern 71 are set to sequentially increase from the center side of the vehicle width direction, and the light quantity of the first light source part 11 is set to the maximum light quantity. The light quantity of the fourth light source part 14 forming the second light distribution pattern 81 is set to be the same as the light quantity of the first light source part 11. The second light distribution pattern 81 can be formed by irradiating light from the fourth light source part 14, which has large light quantity, to the position displaced from the center of the vehicle width direction.

As the above, light from the fourth light source part 14 is irradiated toward not only the road surface 130 but also the objects 131 (e.g., utility poles) on the roadside. The arrangement of the upper edge part 140 of the irradiation range of light directed at the objects on the roadside is determined by the configuration or the state of the optical system 23 corresponding to the fourth light source part 14, the light quantity of the fourth light source part 14, and the like. Moreover, the irradiation range of light by the headlight 2 can be controlled as needed by controlling at least one of the driving of a movable part of the optical system 23 (e.g., by a motor) or the light quantity of the fourth light source part 14 by the light distribution control part 53 (refer to FIG. 3).

Accordingly, even if the vanishing point 122 is moved by turning the vehicle 1 or traveling on an ascent slope, descent slope, or the like, the light distribution of the headlight 2 is properly controlled according to the position of the vanishing point 122 so that the upper edge part 140 of the irradiation area of light directed at the objects on the roadside is constantly arranged to be linearly extended toward the vanishing point 122. Therefore, since the visible space cognitive function of the driver is consistently well performed even when turning the vehicle 1, or traveling on an ascent slope, descent slope, or the like during nighttime driving, the high visual responsiveness can be obtained so that safety during nighttime driving can be enhanced effectively.

The light distribution pattern 90 shown in FIG. 5B consists of a combination of only one second light distribution pattern 81 to the first light distribution pattern 71 shown in FIG. 5C. In the light distribution pattern 90 shown in FIG. 5B, the second light distribution pattern 81 is formed only on the opposite side of the opposing lane (left side of the figure) across the center in the vehicle width direction. Accordingly, in the light distribution pattern 90, the horizontal cutoff line 72 extending to the opposing lane side from the center of the vehicle width direction and the oblique cutoff line 82 extending obliquely upward toward the opposite side of the opposing lane from the center of the vehicle width direction.

In the light distribution pattern 90 shown in FIG. 5B, in the vehicle width direction region of the opposing lane side that the horizontal cutoff line 72 is formed, the glare to the oncoming vehicles can be effectively suppressed by cutting irradiation to the upward. Moreover, in the vehicle width direction region on the opposite side of the opposing lane that the second light distribution pattern 81 is formed, light with high illuminance is irradiated toward the vertical direction region that is higher than the horizontal cutoff line 72.

Therefore, when oncoming vehicles are detected by the camera 20, since the light distribution pattern 90 shown in FIG. 5B is formed, the glare to the oncoming vehicles is effectively suppressed and also the upper edge part 140 (refer to FIG. 6) of the irradiation range of light directed at the objects on the roadside of the opposite side of the opposing lane is arranged as described above. Accordingly, the visible space cognitive function of the driver is well performed, and the visual responsiveness of the driver is improved, so that safety during nighttime driving can be enhanced effectively.

Moreover, when the light distribution pattern 90 shown in FIG. 5B is formed, the light quantity of the fourth light source part 14L of the headlight 2L on the opposite side of the opposing lane may be set to be large in the same way as described above (refer to FIG. 7), and the fourth light source part 14 of the headlight 2R on the opposing lane side may be turned off or the light quantity may be set to be small.

### Modification Examples of the Light Source of the Headlight

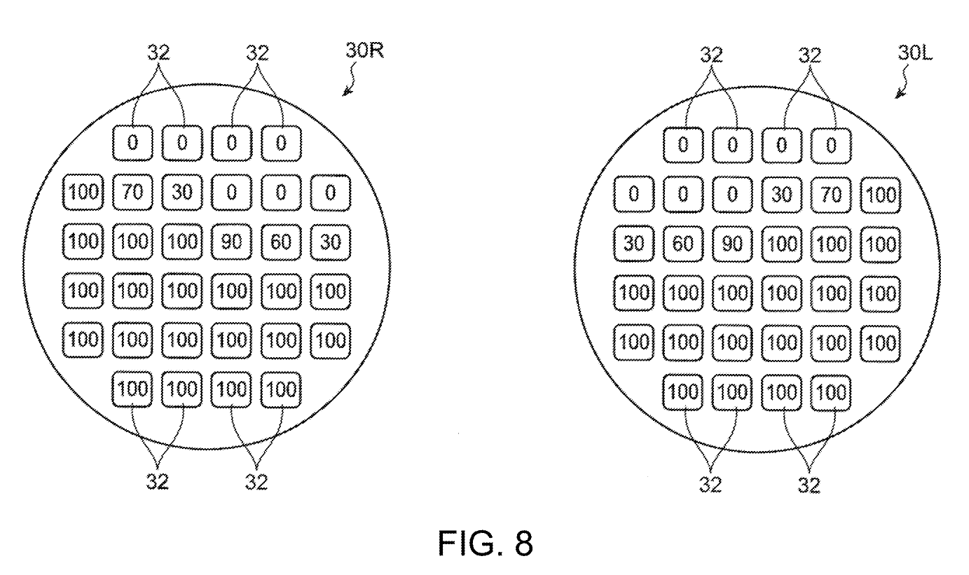

FIG. 8 shows the light source of the headlights 30L and 30R according to the modification examples. The bilateral each headlight 30L and 30R has a plurality of light source parts 32 that are arranged in a plurality of lines to the vertical direction and the vehicle width direction respectively. Each of the light source parts 32 has, for example, at least one LED element.

In FIG. 8, numbers that show the ratio of the light quantity of each light source part 32 to the maximum light quantity are described on the illustrated position of each light source part 32. Moreover, the maximum light quantities of the light source parts 32 are all equal. The ratios of the light quantities of each light source part 32 shown in FIG. 8 are a setting example when forming the light distribution pattern 70 shown in FIG. 5A as described above. Accordingly, by controlling the light quantities of each light source part 32, the shape of the contour of the light distribution pattern and the illuminance distribution can be controlled.

Therefore, when using the light source of the headlights 30L and 30R shown in FIG. 8, the light distribution pattern, which consists of a combination of the first light distribution pattern 71 and the second light distribution pattern 81, can be formed in the same way as described above (for example, the light distribution patterns 70 and 90 shown in FIGS. 5A (A) or 5B (B)). Moreover, the light distribution of the headlights 30L and 30R are properly controlled according to the position of the vanishing point 122 (refer to FIG. 6) by the light distribution control part 53 (refer to FIG. 3), so that safe nighttime driving is possible in the state in which the visible space cognitive function of the driver is constantly performed well.

### Second Embodiment

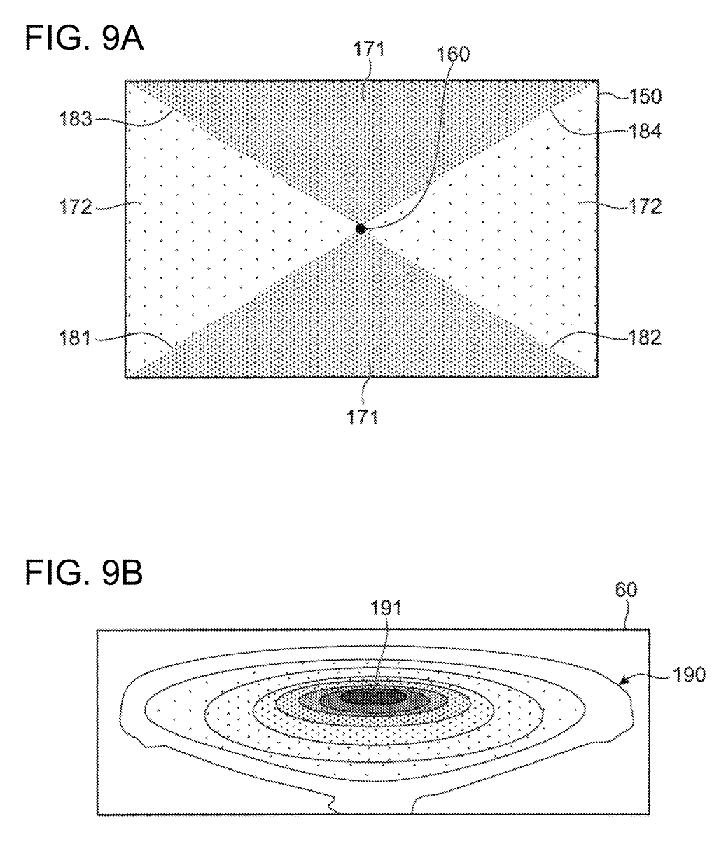

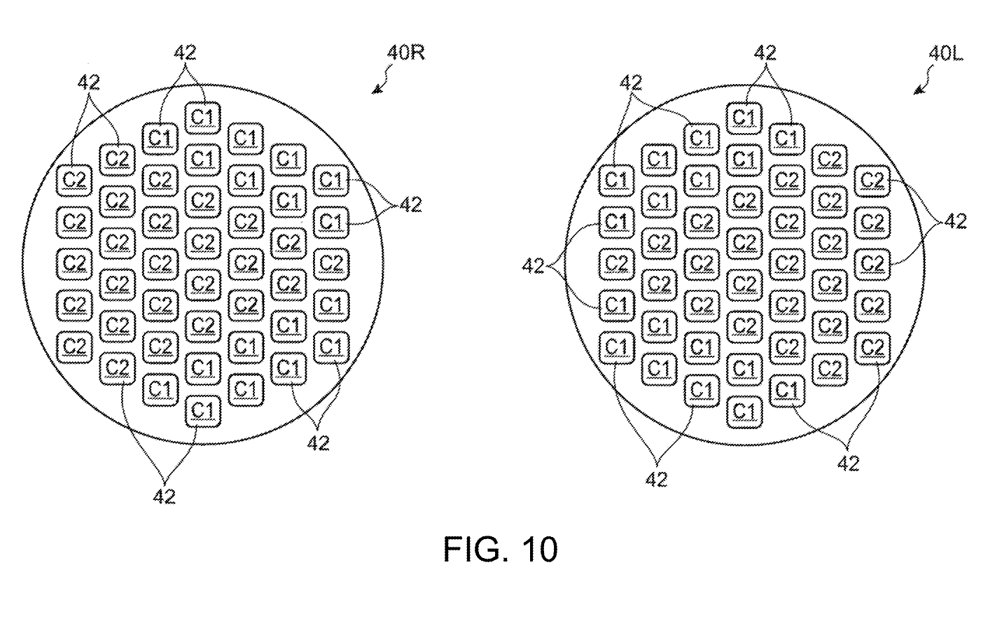

FIG. 9A shows the irradiation mode of light from the headlights 40L and 40R according to the second embodiment, and FIG. 9B shows the pattern of the light distribution of the same headlights 40L and 40R. Moreover, the FIG. 10 shows an example of the light source of the headlights 40L and 40R according to the second embodiment. Further, in the second embodiment, the explanations for the common configurations with the first embodiment are omitted and the same numerical references are denoted on the FIGS. 9A, 9B, 10.

As shown in FIG. 9A, the headlights 40L and 40R according to the second embodiment form the first irradiation area 171 at the first wavelength and the second irradiation area 172 at the second wavelength in the field of view 150 forward of the vehicle 1 by the predetermined light distribution means that has at least one light source and the corresponding optical system 23 thereof

The first irradiation area 171 is formed of a pair of upper and lower parts, for example, and the second irradiation area 172 is formed of a pair of left and right parts, for example. The upper and lower parts of each first irradiation area 171 are arranged adjacent to the left and right parts of the second irradiation area 172. Accordingly, the boundaries 181, 182, 183, and 184 between the first irradiation area 171 and the second irradiation area 172 are formed at four places.

More specifically, the boundaries 181, 182, 183, and 184 are formed at two places each to the left or right of the vanishing point 160 and at two places each above or below the vanishing point 160 in the field of view 150 forward of the vehicle 1. Accordingly, the boundaries 181, 182, 183, and 184 are preferably formed with one or more each to the left or right of the vanishing point 160 and one or more each above or below the vanishing point 160 in the field of view 150 forward of the vehicle 1. However, the number and the arrangement of the boundaries 181, 182, 183, and 184 are not limited to this.

Each of the boundaries 181, 182, 183, and 184 is formed to linearly extend toward the vanishing point 160 in the field of view 150. Since colors of irradiated light between the first irradiation area 171 and the second irradiation area 172 are different, the boundaries 181, 182, 183, and 184 in both regions 171 and 172 can be clearly visually recognized by the driver.

Moreover, the contours of each of the boundaries 181, 182, 183, and 184 may not necessarily be linear but may instead be a curved line.

The irradiation mode shown in FIG. 9A can be realized by the light distribution pattern 190 that is configured in the same way as the general light distribution pattern of the high-beam as shown in FIG. 9B. This light distribution pattern 190 has a contour that is approximately elliptical overall and has the hot zone 191 on a position offset upwardly from the center of the virtual vertical screen 60.

However, in the second embodiment, the configuration of the light distribution pattern is not limited; for example, it may be the general light distribution pattern of the low-beam and it may be the same light distribution patterns 70 and 90 (refer to FIG. 5A 5B) of the first embodiment.

The irradiation mode shown in FIG. 9A can be realized, for example, by using the headlights 40L and 40R that have the light source such as shown in FIG. 10. In an example shown in FIG. 10, each of the headlights 40L and 40R have a plurality of light source parts 42, respectively. Each light source part 42 has, for example, at least one LED element.

Each light source part 42 emits either light of the first color C1 at the first wavelength or the light of the second color C2 at the second wavelength. Moreover, in FIG. 10, the light colors (the first color C1 or the second color C2) that each light source part 42 emits are described on the illustrated position of each light source part 42. Each light source part 42 may be configured so as to be able to emit light only one predetermined color, or may be configured so as to be able to emit light by selecting a color between the first color C1 and the second color C2.

The arrangements of the boundaries 181, 182, 183, and 184 between the first irradiation area 171 and the second irradiation area 172 shown in FIG. 9A are determined by the light color emitted from each light source part 42 and the configuration or the state of the optical system 23. Moreover, as needed, arrangements of the boundaries 181, 182, 183, and 184 of the color of the irradiated light in the field of view 150 can be controlled by controlling at least one of the driving of the movable part of the optical system 23 or the color of each light source part 42 by the light distribution control part 53 (refer to FIG. 3).

Accordingly, even if the vanishing point 160 is moved by turning the vehicle 1, or traveling on an ascent slope, descent slope, or the like, the light distributions of the headlights 40L and 40R are properly controlled according to the position of the vanishing point 160, so that the boundaries 181, 182, 183, and 184 of the color of the irradiated light of the headlights 40L and 40R can be constantly arranged to linearly extend toward the vanishing point 160.

Accordingly, based on the direction to which boundaries 181, 182, 183, and 184 of the color of the irradiated light of the headlights 40L and 40R extend during nighttime driving, the driver easily perceives the position of the vanishing point 160, and consequently the traveling direction of the vehicle 1. Accordingly, since the visible space cognitive function of the driver is easily performed well, the visual responsiveness of the driver during nighttime driving can be improved, so that safety during nighttime driving can be enhanced.

### Third Embodiment

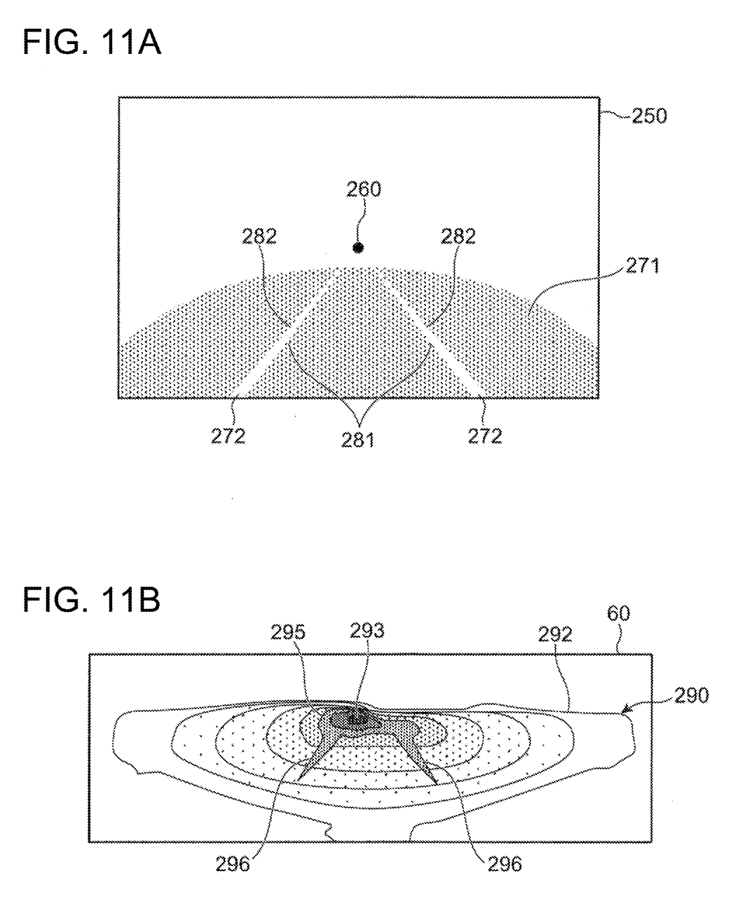

FIG. 11A shows the irradiation mode of light from the headlight according to the third embodiment, and FIG. 11B shows the light distribution pattern of the same headlight. Moreover, in the third embodiment, the same configurations as in the first embodiment are not described and are denoted by the same reference characters in FIGS. 11A and 11B.

As shown in FIG. 11A, the headlight irradiates light with the first illuminance toward the first irradiation area 271 in the field of view 250 forward of the vehicle 1 and irradiates light with the second illuminance toward the second irradiation area 272 consisting of a part of the first irradiation area 271, by the predetermined light distribution means that has at least one light source and the corresponding optical system 23 thereof. For example, the second illuminance may be higher than the first illuminance.

Moreover, the second illuminance may be lower than the first illuminance. However, the difference between the first illuminance and the second illuminance is greater than or equal to the minimum illuminance difference at which the contour of the second irradiation area 272 can be clearly visually recognized.

More specifically, the irradiation range of light from the headlight according to the third embodiment has the first irradiation area 271 that is formed over a wide range and a pair of second irradiation areas 272 formed linearly so as to divide the first irradiation area 271. One side of the second irradiation area 272 is formed to the left of the vanishing point 260 and the other side of the second irradiation area 272 is formed to the right of the vanishing point 260. However, the number and the arrangement of the second irradiation area 272 are not limited to this.

Each second irradiation area 272 is, for example, configured in the linear area expanding toward the vanishing point 260 in the field of view 250. Each second irradiation area 272 has contour parts 281 and 282 expanding toward the vanishing point 260 in the field of view 250 at the boundary of the first irradiation area 271. The contour parts 281 and 282 are formed as a pair of left and right parts.

Since the illuminance of the irradiated light between the first irradiation area 271 and the second irradiation area 272 are different, the direction to which the second irradiation area 272 and the contour parts 281 and 282 thereof expand can be clearly visually recognized by the driver.

The irradiation mode shown in FIG. 11A for example, can be realized by the light distribution pattern 290 shown in FIG. 11B. The light distribution pattern 290 shown in FIG. 11B is configured based on the general light distribution pattern of the low-beam. Therefore, the light distribution pattern 290 has a horizontal cutoff line 292 on the upper edge part thereof and also a hot zone 293 immediately under the horizontal cutoff line 292 on the central region of the vehicle width direction.

In the light distribution pattern 290 shown in FIG. 11B, a pair of left and right extension parts 296, which extend in the downwardly inclined direction outward in the vehicle width direction, are formed on a zone 295 of relatively high luminance that is formed so as to surround the hot zone 293. The irradiated light forming these extension parts 296 on the virtual vertical screen 60 forms the second irradiation area 272 on the field of view 250 forward of the vehicle.

However, in the third embodiment, the configuration of the light distribution pattern is not particularly limited. For example, it may be configured based on the general light distribution pattern of the high-beam, or it may be a configuration based on the same light distribution patterns 70 and 90 (refer to FIGS. 5A 5B) as the first embodiment.

The irradiation mode shown in FIG. 11 (A) can be realized by using the headlights 30L and 30R having the light source(s) shown in FIG. 8, for example. By properly adjusting the light quantity of each light source part 32 and the configuration and the state of the optical system 23 on the headlights 30L and 30R, the irradiation mode shown in FIG. 11A can be realized. Moreover, the arrangement of the second irradiation area 272 in the field of view 250 can be controlled as needed by controlling at least one of the driving of the movable part of the optical system 23 or the light quantity of each light source part 32 by the light distribution control part 53 (refer to FIG. 3).

Accordingly, even if the vanishing point 260 is moved by turning the vehicle 1, or traveling on an ascent slope or a descent slope, and the like, the light distribution of the headlights 30L and 30R are properly controlled according to the position of the vanishing point 260, so that the second irradiation area 272 and the contour parts 281 and 282 thereof are constantly arranged to linearly extend toward the vanishing point 260.

Accordingly, based on the direction to which the second irradiation area 272 and boundaries 181, 182, 183, and 184 thereof extend during nighttime driving, the driver easily perceives the position of the vanishing point 260, and consequently the traveling direction of the vehicle 1. Accordingly, since the visible space cognitive function of the driver is easily performed well, the visual responsiveness of the driver during nighttime driving can be improved, so that safety during nighttime driving can be enhanced.

Moreover, in the third embodiment, when the irradiated light forming the second irradiation area 272 is directed at the road surface, even though there is no object on the roadside or the light is not irradiated toward the objects on the roadside, based on the direction to which the second irradiation area 272 of the irradiated light directed toward the road surface and the contour parts 281 and 282 thereof extend, the driver can perceive the position of the vanishing point 260 accurately. Accordingly, regardless of the surrounding conditions of the road surface, the visible space cognitive function of the driver is performed well, so that safety during nighttime driving can be enhanced.

Moreover, in the third embodiment, although both of each second irradiation area 272 and the bilateral contour parts 281 and 282 thereof are formed to linearly extend toward the vanishing point 260, as long as at least one of the contour parts of the second irradiation area 272 is formed to linearly extend toward the vanishing point 260, the direction and the shape of other contour parts and the shape of the second irradiation area 272 are not particularly limited.

As described above, although the present invention is described with these embodiments, the present invention is not limited the above described embodiments.

For example, in each embodiment, although an example of using the camera 20 as the detection means for detecting information about the traveling direction of the vehicle was described, in addition to the camera 20, a steering angle sensor 21 (refer to FIG. 3) for detecting the turning state of the vehicle 1 and/or a gradient sensor 22 (refer to FIG. 3) for detecting the gradient of the road surface may be used. In this case, the vanishing point calculation part 52 (refer to FIG. 3) may calculate the traveling direction of the vehicle 1 and the position of the vanishing point based on the information related to the turning state of vehicle 1 detected by the steering angle sensor 21 and the information related to the gradient of the road surface detected by the gradient sensor 22.

Moreover, in each embodiment, although an example of using LEDs as the light source of the vehicle headlight is described, in the present invention, the light source of the vehicle headlight is not limited to LEDs. For example, a halogen lamp or high-intensity discharge (HID) lamp may be used.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### INDUSTRIAL APPLICABILITY

As described above, according to the present invention, since it is possible to realize the light distribution of the vehicle headlight that can improve the visual responsiveness of the driver during nighttime driving, it can be utilized suitably in the manufacturing industrial fields of vehicle headlights and vehicles having vehicle headlights.

### EXPLANATION OF REFERENCE CHARACTERS

1 Vehicle

2, 30, 40 Headlight (vehicle headlight)

11-15 Light source part

20 Camera (Imaging means)

32,42 Light source part

50 Control unit

51 Optical flow calculation part

52 Vanishing point calculation part (Vanishing point calculation means)

53 Light distribution control part (Control means)

60 Virtual vertical screen

70, 90 Light distribution pattern

71 First light distribution pattern

73 Hot zone

81 Second light distribution pattern

83 Hot zone

120 Field of view forward of the vehicle

122 Vanishing point

130 Road surface

131 Utility pole (Objects on roadside)

140 Upper edge part of irradiation range

150 Field of view forward of the vehicle

160 Vanishing point

171 First irradiation area

172 Second irradiation area

181-184 Boundary

250 Field of view forward of the vehicle

260 Vanishing point

271 First irradiation area

272 Second irradiation area

281, 282 Contour part

We claim:

1. A vehicle headlight, comprising:
at least one light source configured to radiate light; and
a processor configured to control the at least one light source to:
direct light to the road surface forward of a vehicle, for forming a first light distribution pattern having a hot zone in a central region in a vehicle width direction, and
direct light to a roadside forward of the vehicle, for forming a second light distribution pattern, which has a hot zone on a position offset outwardly in the vehicle width direction from the hot zone of the first light distribution pattern, in an overlapped region with the first light distribution pattern, wherein
an irradiation range of light directed at objects on the roadside has an upper edge part that extends in a direction inclined inwardly in the vehicle width direction forward of the vehicle.

2. The vehicle headlight according to claim 1, wherein
an upper edge part of the irradiation range is a linear part provided so as to extend toward a vanishing point in the field of view forward of the vehicle.

3. The vehicle headlight according to claim 2, wherein
an illuminance of the hot zone of the second light distribution pattern is equivalent to an illuminance of the hot zone in the first light distribution pattern.

4. The vehicle headlight according to claim 1, wherein
an illuminance of the hot zone of the second light distribution pattern is equivalent to an illuminance of the hot zone in the first light distribution pattern.

5. A vehicle headlight, comprising:
at least one first light source for emitting light at a first wavelength,
at least one second light source for emitting light at a second wavelength, and
a processor configured to control the first and second light sources for forming a first irradiation area, to which the light emitted from the at least one first light source is radiated, and a second irradiation area, to which the light emitted from the at least one second light source is radiated, to be adjacent to each other, and for forming a boundary between the first irradiation area and the second irradiation area so as to extend toward a vanishing point, in the field of view forward of a vehicle.

6. A vehicle headlight, comprising:
at least one light source configured to radiate light; and
a processor configured to control the at least one light source to radiate light with a first illuminance toward a first irradiation area in the field of view forward of a vehicle, form a second irradiation area having a contour part extended toward a vanishing point in the field of view forward of the vehicle, and radiate light with a second illuminance toward the second irradiation area.

7. The vehicle headlight according to claim 3, further comprising a camera for filming scenes forward of the vehicle,
wherein the processor is further configured to calculate the vanishing point based on the filmed scenes.
